(19) United States
(12) Patent Application Publication
(10) Pub. No.: US 2026/0073144 A1
(43) Pub. Date: Mar. 12, 2026

(54) FIELD DATA FRAMEWORK

(71) Applicant: Schlumberger Technology Corporation, Sugar Land, TX (US)

(72) Inventors: Yuan Wang, Stanford, CA (US); Neelansh Garg, Menlo Park, CA (US); Monisha Manoharan, Menlo Park, CA (US)

(21) Appl. No.: 19/326,050

(22) Filed: Sep. 11, 2025

Related U.S. Application Data
(60) Provisional application No. 63/693,329, filed on Sep. 11, 2024.

(51) Int. Cl. G06F 40/289; G06F 40/40; G06T 11/20

(52) U.S. Cl. CPC G06F 40/289; G06F 40/40; G06T 11/26; G06T 2200/24

(57) ABSTRACT

A method can include receiving input text associated with field operations at a field site that includes at least one well in fluid communication with a reservoir; assessing the input text with respect to one or more criteria to generate one or more chunks of text from the input text; directing the one or more chunks of text and a prompt to a large language model to generate corresponding output; and transforming the corresponding output into a graph structure, where the graph structure includes nodes and edges, and where each of the edges describes a relationship between a pair of the nodes.

### RELATED APPLICATION

This application claims priority to and the benefit of a U.S. Provisional Application having Ser. No. 63/693,329, filed 11 Sep. 2024, which is incorporated by reference herein in its entirety.

### BACKGROUND

A sedimentary basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Such a reservoir can be a subsurface formation characterized by physical properties such as, for example, porosity and fluid permeability.

A reservoir may be developed using one or more technologies. For example, consider drilling and completing wells that may be in fluid communication with the reservoir. As an example, a well may be a production well or an injection well. As to production, consider production of hydrocarbons, which may be in one or more phases (e.g., gas, liquid, etc.). As to injection, consider injection of water as may be utilized in waterflooding, injection of chemical treatments, injection of carbon dioxide as may be part of a carbon capture and/or carbon sequestration process, etc.

As an example, a basin may include one or more fields that may be developed over time. Before, during and/or after development, various reports may be generated that may include text, graphics, etc. In various instances, challenges may exist in extracting meaningful information from such reports. As an example, a framework may provide for extracting such information and, for example, storing such information in a manner that may facilitate future access, training of one or more machine learning models, etc.

### SUMMARY

A method can include receiving input text associated with field operations at a field site that includes at least one well in fluid communication with a reservoir; assessing the input text with respect to one or more criteria to generate one or more chunks of text from the input text; directing the one or more chunks of text and a prompt to a large language model to generate corresponding output; and transforming the corresponding output into a graph structure, where the graph structure includes nodes and edges, and where each of the edges describes a relationship between a pair of the nodes. A system can include a processor; a memory operatively coupled to the processor; and processor-executable instructions stored in the memory and executable to instruct the system to: receive input text associated with field operations at a field site that includes at least one well in fluid communication with a reservoir; assess the input text with respect to one or more criteria to generate one or more chunks of text from the input text; direct the one or more chunks of text and a prompt to a large language model to generate corresponding output; and transform the corresponding output into a graph structure, where the graph structure includes nodes and edges, and where each of the edges describes a relationship between a pair of the nodes. One or more computer-readable storage media can include processor-executable instructions executable by a system to instruct the system to: receive input text associated with field operations at a field site that includes at least one well in fluid communication with a reservoir; assess the input text with respect to one or more criteria to generate one or more chunks of text from the input text; direct the one or more chunks of text and a prompt to a large language model to generate corresponding output; and transform the corresponding output into a graph structure, where the graph structure includes nodes and edges, and where each of the edges describes a relationship between a pair of the nodes.

Various other apparatuses, systems, methods, etc., are also disclosed. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates an example of a system;

FIG. 3 illustrates an example of a workflow;

FIG. 4 illustrates an example of a workflow;

FIG. 5 illustrates examples of inputs and a knowledge graph;

FIG. 6 illustrates an example of chunking;

FIG. 7 illustrates an example of an architecture;

FIG. 8 illustrates an example of an architecture;

FIG. 9 illustrates an example of a method and an example of a system; and

FIG. 10 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Below, various types of environments, frameworks, workflows, data acquisition techniques, etc., are described, which may involve use of seismic survey data, for example, as processed using a seismic survey framework.

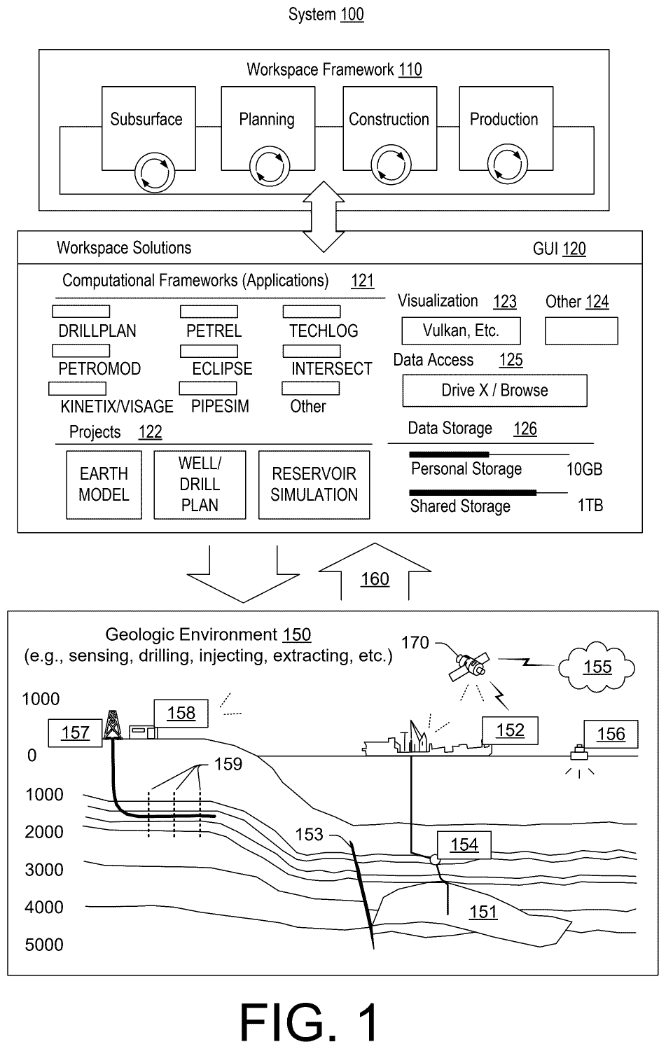

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. A geologic environment 150 may be outfitted with a variety of sensors, detectors, actuators, etc. In such an environment, various types of equipment such as, for example, equipment 152 may include communication circuitry to receive and to transmit information, optionally with respect to one or more networks 155. Such information may include information associated with downhole equipment 154, which may be equipment to acquire information, to assist with resource recovery, etc. Other equipment 156 may be located remote from a wellsite and include sensing, detecting, emitting, or other circuitry. Such equipment may include storage and communication circuitry to store and to communicate data, instructions, etc. One or more satellites may be provided for purposes of communications, data acquisition, etc. For example, FIG. 1 shows a satellite 170 in communication with the network 155 that may be configured for communications, noting that the satellite 170 may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc., may exist where an assessment of such variations may assist with planning, operations, etc., to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, INTERSECT, KINETIX/VISAGE, and PIPESIM frameworks (SLB, Houston, Texas). One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). Such an environment can provide for operations that involve one or more frameworks. The DELFI environment may be referred to as the DELFI framework, which may be a framework of frameworks. The DELFI environment can include various other frameworks, which may operate using one or more types of models (e.g., simulation models, etc.).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator with numerical solvers for prediction of dynamic behavior for various types of reservoirs and development schemes.

The INTERSECT framework provides a high-resolution reservoir simulator for simulation of geological features and quantification of uncertainties, for example, by creating production scenarios and, with the integration of precise models of the surface facilities and field operations, the INTERSECT framework can produce results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal FOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases.

The KINETIX framework provides for reservoir-centric stimulation-to-production analyses that can integrate geology, petrophysics, completion engineering, reservoir engineering, and geomechanics, for example, to provide for optimized completion and fracturing designs for a well, a pad, or a field. The KINETIX framework can be operatively coupled to and/or integrated with features of the PETREL framework (e.g., within the DELFI environment). As to the VISAGE framework it can be part of or otherwise operatively coupled to the KINETIX framework.

The VISAGE framework includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO2 disposal, etc.

As an example, the KINETIX framework can provide for analyses from 1D logs and simple geometric completions to 3D mechanical and petrophysical models coupled with the INTERSECT framework high-resolution reservoir simulator and VISAGE framework finite-element geomechanics simulator. The KINETIX framework can provide automated parallel processing using cloud platform resources and can provide for rapid assessment of well spacing, completion, and treatment design choices, enabling exploration of many scenarios in a relatively rapid manner (e.g., via provisioning of cloud platform resources). The KINETIX framework may be operatively coupled to the MANGROVE simulator (SLB, Houston, Texas), which can provide for optimization of stimulation design (e.g., stimulation treatment operations such as hydraulic fracturing) in a reservoir-centric environment.

The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). The PIPESIM simulator may be an optimizer that can optimize one or more operational scenarios at least in part via simulation of physical phenomena.

As an example, a framework with features for performing drilling operations, etc., may be included in the system 100. For example, consider the DRILLOPS framework (SLB, Houston, Texas), which may execute a digital drilling plan and ensures plan adherence, while delivering goal-based automation. The DRILLOPS framework may generate activity plans automatically for operations, whether they are monitored and/or controlled on the rig or in town. Automation may utilize data analysis and learning systems to assist and optimize tasks, such as, for example, setting rate of penetration (ROP) to drilling a stand. A preset menu of automatable drilling tasks may be rendered, and, using data analysis and models, a plan may be executed in a manner to achieve a specified goal, where, for example, measurements may be utilized for calibration. The DRILLOPS framework provides flexibility to modify and replan activities dynamically, for example, based on a live appraisal of various factors (e.g., equipment, personnel, and supplies). Well construction activities (e.g., tripping, drilling, cementing, etc.) may be continually monitored and dynamically updated using feedback from operational activities. The DRILLOPS framework may provide for various levels of automation based on planning and/or re-planning (e.g., via the DRILLPLAN framework), feedback, etc.

As an example, a framework with features for performing seismic data related operations, etc., may be included in the system 100. For example, consider the OMEGA framework (SLB, Houston, Texas), which includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density. The OMEGA framework also includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools. Various features can be included for processing various types of data such as, for example, one or more of: land, marine, and transition zone data; time and depth data; 2D, 3D, and 4D surveys; isotropic and anisotropic (TTI and VTI) velocity fields; and multicomponent data.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150, and feedback 160 can be received via one or more interfaces in one or more forms (e.g., acquired data as to operational conditions, equipment conditions, environment conditions, etc.).

As an example, a platform, such as, for example, the LUMI platform (SLB, Houston, Texas) may be utilized. The LUMI platform includes features that provide for artificial intelligence solutions as may be integrated with data management capabilities. The LUMI platform provides for flexible deployment options and an open, secure, and modular architecture, for example, to empower data-driven decision-making. The LUMI platform is operable with the DELFI environment and, hence, one or more of various frameworks. While various platforms, environments, frameworks, libraries, etc., are mentioned, a framework may be operable in an agnostic manner, for example, to be compatible with one or more other platforms, environments, frameworks, libraries, technologies, etc.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

Visualization features may provide for visualization of various earth models, properties, etc., in one or more dimensions. As an example, visualization features may include one or more control features for control of equipment, which can include, for example, field equipment that can perform one or more field operations. A workflow may utilize one or more frameworks to generate information that can be utilized to control one or more types of field equipment (e.g., drilling equipment, wireline equipment, fracturing equipment, etc.). As an example, a framework such as the Vulkan framework (Khronos Group, Beaverton, Oregon) may be available or otherwise accessible for implementing various visualization techniques, etc. The Vulkan framework may provide relatively a low-level, low-overhead cross-platform API and open standard for 3D graphics and computing.

As to a reservoir model that may be suitable for utilization by a simulator, consider acquisition of seismic data as acquired via reflection seismology, which finds use in geophysics, for example, to estimate properties of subsurface formations. Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.). Field acquisition equipment may be utilized to acquire seismic data, which may be in the form of traces where a trace can include values organized with respect to time and/or depth (e.g., consider 1D, 2D, 3D or 4D seismic data).

A model may be a simulated version of a geologic environment where a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

While several simulators are illustrated in the example of FIG. 1, one or more other simulators may be utilized, additionally or alternatively.

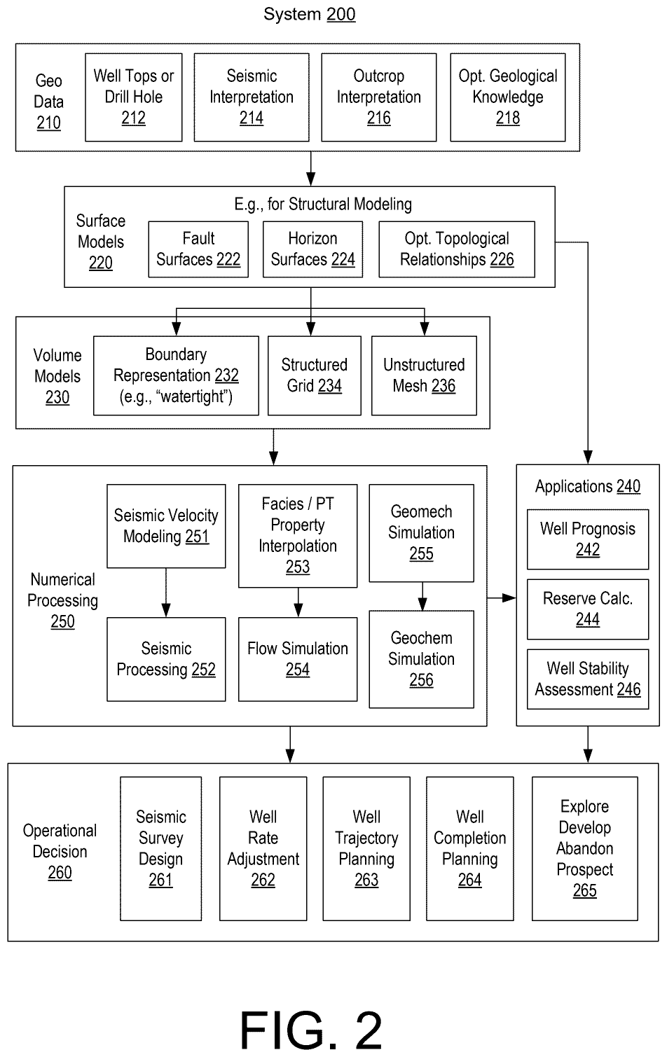

FIG. 2 shows an example of a system 200 that can be operatively coupled to one or more databases, data streams, etc. For example, one or more pieces of field equipment, laboratory equipment, computing equipment (e.g., local and/or remote), etc., can provide and/or generate data that may be utilized in the system 200.

As shown, the system 200 can include a geological/geophysical data block 210, a surface models block 220 (e.g., for one or more structural models), a volume modules block 230, an applications block 240, a numerical processing block 250 and an operational decision block 260. As shown in the example of FIG. 2, the geological/geophysical data block 210 can include data from well tops or drill holes 212, data from seismic interpretation 214, data from outcrop interpretation and optionally data from geological knowledge. As an example, the geological/geophysical data block 210 can include data from digital images, which can include digital images of cores, cuttings, cavings, outcrops, etc. As to the surface models block 220, it may provide for creation, editing, etc. of one or more surface models based on, for example, one or more of fault surfaces 222, horizon surfaces 224 and optionally topological relationships 226. As to the volume models block 230, it may provide for creation, editing, etc. of one or more volume models based on, for example, one or more of boundary representations 232 (e.g., to form a watertight model), structured grids 234 and unstructured meshes 236.

As shown in the example of FIG. 2, the system 200 may allow for implementing one or more workflows, for example, where data of the data block 210 are used to create, edit, etc. one or more surface models of the surface models block 220, which may be used to create, edit, etc. one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrophysical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 252, a well trajectory planning process 263, a well completion planning process 264 and a process for one or more prospects, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g. fault A truncates fault B, fault B intersects fault C, etc.).

As to the one or more boundary representations 232, they may include a numerical representation in which a subsurface model is partitioned into various closed units representing geological layers and fault blocks where an individual unit may be defined by its boundary and, optionally, by a set of internal boundaries such as fault surfaces.

As to the one or more structured grids 234, it may include a grid that partitions a volume of interest into different elementary volumes (cells), for example, that may be indexed according to a pre-defined, repeating pattern. As to the one or more unstructured meshes 236, it may include a mesh that partitions a volume of interest into different elementary volumes, for example, that may not be readily indexed following a pre-defined, repeating pattern (e.g., consider a Cartesian cube with indexes I, J, and K, along x, y, and z axes).

As to the seismic velocity modeling 251, it may include calculation of velocity of propagation of seismic waves (e.g., where seismic velocity depends on type of seismic wave and on direction of propagation of the wave). As to the seismic processing 252, it may include a set of processes allowing identification of localization of seismic reflectors in space, physical characteristics of the rocks in between these reflectors, etc.

As to the facies and petrophysical property interpolation 253, it may include an assessment of type of rocks and of their petrophysical properties (e.g., porosity, permeability), for example, optionally in areas not sampled by well logs or coring. As an example, such an interpolation may be constrained by interpretations from log and core data, and by prior geological knowledge.

As to the flow simulation 254, as an example, it may include simulation of flow of hydro-carbons in the subsurface, for example, through geological times (e.g., in the context of petroleum systems modeling, when trying to predict the presence and quality of oil in an un-drilled formation) or during the exploitation of a hydrocarbon reservoir (e.g., when some fluids are pumped from or into the reservoir).

As to geomechanical simulation 255, it may include simulation of the deformation of rocks under boundary conditions. Such a simulation may be used, for example, to assess compaction of a reservoir (e.g., associated with its depletion, when hydrocarbons are pumped from the porous and deformable rock that composes the reservoir). As an example, a geomechanical simulation may be used for a variety of purposes such as, for example, prediction of fracturing, reconstruction of the paleo-geometries of the reservoir as they were prior to tectonic deformations, etc.

As to geochemical simulation 256, such a simulation may simulate evolution of hydrocarbon formation and composition through geological history (e.g., to assess the likelihood of oil accumulation in a particular subterranean formation while exploring new prospects).

As to the various applications of the applications block 240, the well prognosis application 242 may include predicting type and characteristics of geological formations that may be encountered by a drill bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

The system 200 can include and/or can be operatively coupled to a system such as the system 100 of FIG. 1. For example, the workspace framework 110 may provide for instantiation of, rendering of, interactions with, etc., the graphical user interface (GUI) 120 to perform one or more actions as to the system 200. In such an example, access may be provided to one or more frameworks (e.g., DRILLPLAN, PETREL, TECHLOG, PETROMOD, ECLIPSE, INTERSECT, KINETIX/VISAGE, PIPESIM, DRILLOPS, OMEGA, etc.). One or more frameworks may provide for geo data acquisition as in block 210, for structural modeling as in block 220, for volume modeling as in block 230, for running an application as in block 240, for numerical processing as in block 250, for operational decision making as in block 260, etc.

As an example, the system 200 may provide for monitoring data, which can include geo data per the geo data block 210. In various examples, geo data may be acquired during one or more operations. For example, consider acquiring geo data during drilling operations via downhole equipment and/or surface equipment. As an example, the operational decision block 260 can include capabilities for monitoring, analyzing, etc., such data for purposes of making one or more operational decisions, which may include controlling equipment, revising operations, revising a plan, etc. In such an example, data may be fed into the system 200 at one or more points where the quality of the data may be of particular interest. For example, data quality may be characterized by one or more metrics where data quality may provide indications as to trust, probabilities, etc., which may be germane to operational decision making and/or other decision making.

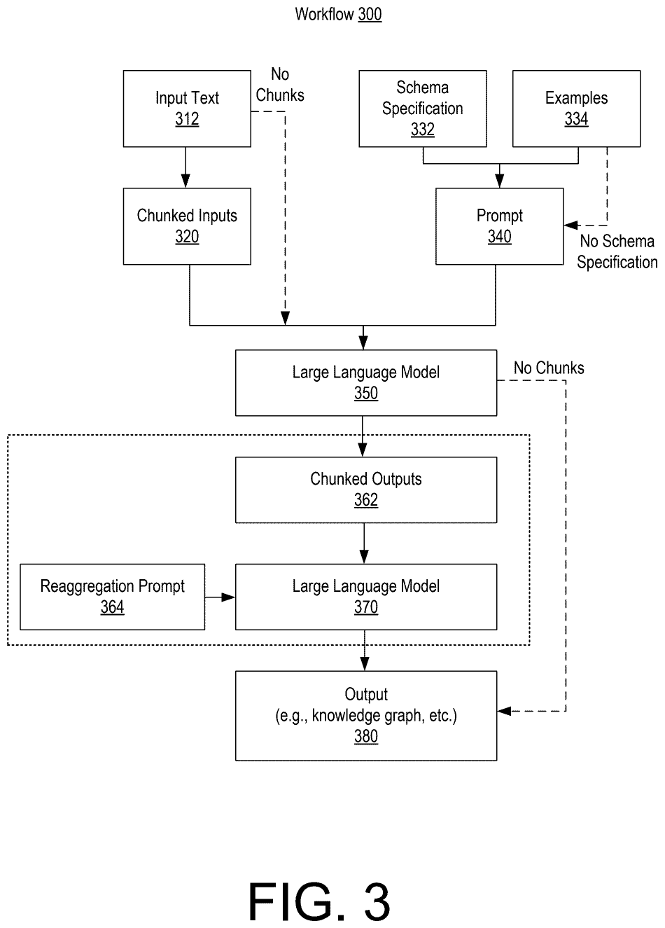

FIG. 3 shows an example of a workflow 300 that can receive input text 312, a schema specification 332, and examples 334. As shown, the input text 312 may be chunked as chunked inputs 320 and the schema specification 332 and the examples 334 may provide for generation of a prompt 340.

As shown in FIG. 3, given the chunked inputs 320 and the prompt 340, a large language model (LLM) 350 may be utilized to generate chunked outputs 352. Such chunked outputs 352 may be directed to another LLM 370 that may also receive a reaggregation prompt 364 to generate output 380, which may include output in one or more forms such as, for example, a knowledge graph. In the example of FIG. 3, various dashed lines with arrows indicate some alternative pathways for the workflow 300. For example, if chunking the input text 312 into the chunked inputs 320 is not performed, then the LLM 370 may proceed to generate the output 380 without utilization of the reaggregation prompt 364 and without resubmission to the LLM 370 (e.g., which may be the same LLM as the LLM 350). As shown, in various instances, the schema specification 332 may not be provided such that the examples 334 are utilized without a schema specification for generation of the prompt 340.

As for the schema specification 332, it may be considered a specified structure, grammar, etc., where the examples 334 adhere to these structures and grammars. For instance, the schema specification 332 may provide for embedding various entities relevant to domains such as oil and gas or carbon capture. These domains typically involve one or more reservoirs and one or more wells that may be in fluid communication with at least one reservoir. The schema specification 332 can facilitate knowledge extraction from data (e.g., various inputs). For example, it may provide for the utilization of well names, descriptions of wells, etc. The schema specification 332 could apply to various types of fields, reservoirs, wells, etc. Consider, for instance, a schema specification 332 for an onshore well, an offshore well, a conventional reservoir, or an unconventional reservoir. In such cases, a corpus may be associated with a particular setting or technology. For example, a corpus might be a set of terms used to identify and describe an onshore well (e.g., a land-based well) for an unconventional reservoir or an offshore well for a conventional reservoir. In such examples, some common terms may exist, while other terms may differ. Additionally, a schema specification 332 may be geographical; for instance, consider a Gulf of Mexico schema and a Permian Basin schema.

As an example, the input text 312 may be expected to include text that can be related to or otherwise associated with terms in a schema specification 332, which may, for example, be organized in one or more hierarchical manners. For example, as to a hierarchy, consider a well as being at a location and including a wellbore that may be completed using various equipment, which may be arranged in sections, etc. Such a wellbore may be described using terms such as vertical section, dogleg section, lateral section, etc. In such an approach, a well may be considered to be an entity at the top of a hierarchy where various entities may be at lower levels and collectively describe the well at some level of detail for a particular purpose, etc. As an example, an output such as the output 380 may be for a report where, for example, the report is to be for a well, an operator, etc., with details as to one or more flow rates, etc. Hence, various aspects related to a well may be inherent in a schema specification where such aspects may be extracted from data such as, for example, textual data, graphical data, etc., as may be present in documents, etc. As an example, where graphical data are provided, optical character recognition (OCR) and/or one or more other text recognition and/or numerical recognition techniques may be employed. As to numerical recognition, consider recognizing numerical values in a plot of production flow rates versus time where a data structure may be generated such as flow rate of X gpm on a particular date. Hence, numerical data may be cast into a natural language form for purposes of generating suitable input text.

As to types of documents that may be accessible, consider historic reports, daily drilling reports, test results, drilling plans, completions plans, mitigation plans, safety plans, incident reports, regulatory reports, etc. Such documents may include text and may include graphics where such graphics include text that may be assessed for purposes of generating natural language such as sentences for use as input text.

As an example, input may come from a single document or a group of documents. As a single document example, consider a well report that may be in the form of a portable document file (PDF) that can be consumed via an upload (e.g., file navigation and select, drag-n-drop, etc.). In such an example, a graphical user interface (GUI) may be rendered to a display that may provide for selection of various terms, categories, etc., of the well report that may thereby be part of a schema specification, which may be created on-the-fly, modified from an existing schema specification, checked against an existing schema specification, etc.

As an example, a method may provide for selecting a schema specification based on a type of document, which may be an automatic process. Or, for example, a method may include selecting a schema specification with knowledge of a type of document to be uploaded. For example, for a well report document, a well report schema specification may be selected. As an example, a method may utilize a default schema specification. In such an example, a method may include quality controlling a schema specification with respect to a document, for example, to assure that a suitable match exists between what is in the document and what is in the schema specification.

As to the examples 334, these may provide for reduction of hallucinations by an LLM. A hallucination may be considered to be a type of phenomenon where an LLM (e.g., a generative AI chatbot, computer vision tool, etc.) perceives patterns or objects that are nonexistent or imperceptible to human observers, creating outputs that are nonsensical or altogether inaccurate. For example, responsive to a prompt, it may be expected that an LLM will generate output that appropriately addresses the prompt (e.g., a proper answer to a question). However, sometimes an LLM will produce outputs that are not based on training data, that are not properly decoded by a transformer, or that do not follow an identifiable pattern. Hence, the response (e.g., the output) is considered to be a hallucinated response.

Regarding the examples 334, consider one or more sentences and/or short phrases such as, for example: “well A has a dogleg severity of 3 degrees per 100 feet”; “well B has a production rate of 28 barrels per day”; “well C has a gas-to-oil ratio of less than 15000 cubic feet per barrel”; etc. Such examples may help to structure output such that risk of hallucinations are reduced.

As shown, the prompt 340 may be generated according to the schema specification 332 with guidance from the examples 334. As explained, the prompt 340 and the chunked inputs may be received by the LLM 350 to generate the chunked outputs 362.

As explained, the workflow 300 can provide for generation of the output 380 for the given input text 312 and the prompt 340 where the output 380 may be in a logistical form, for example, as answers to questions, which may be graphically structured. As an example, a graphical structure may provide for discerning answers to various questions via the single graphical representation (e.g., a graphical structure that includes digital data and/or digital instructions that can be stored in a memory device, etc., for access, revision, rendering, etc.). As an example, a graphical representation (e.g., a graphical structure) may explain the input text 312 such a way that it is effectively distilled into a form where answers may be automatically derived.

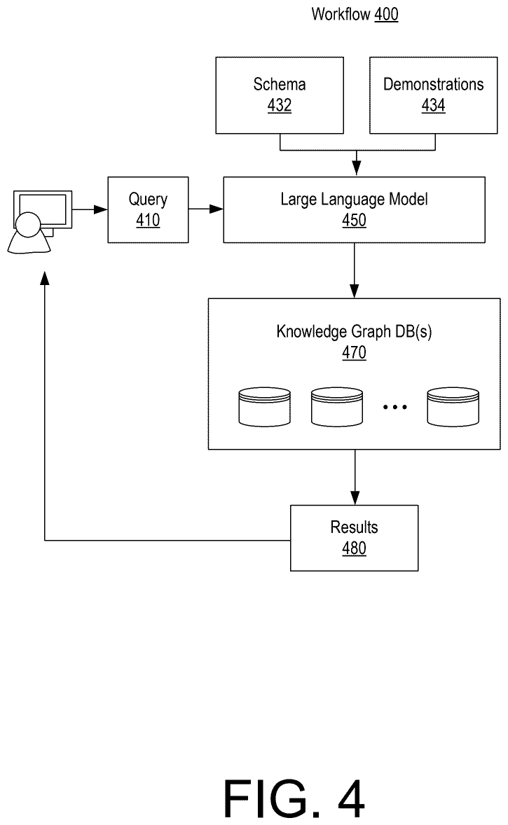

FIG. 4 shows an example of a workflow 400 for querying one or more knowledge graph databases 470 using an LLM. Natural language interfaces may be utilized for querying large knowledge graphs as they allow non-expert users to access and interact with complex data systems in a user-friendly way. Unlike query languages like SPARQL, which require a deep understanding of the structure and syntax of the language, natural language interfaces may enable users to pose queries in a familiar and relatively plain human language. Such an approach may open data exploration to a broader audience, allowing more people to derive insights and make decisions based on the data in knowledge graphs. Additionally, natural language interfaces may be more flexible and adaptable to ambiguous queries, making them a more practical choice for real-world data interrogation scenarios.

A published patent application entitled “Generation and use of searchable graph data structure based on ontological knowledge”, having Serial No. PCT/US2023/032125, published as WO2024058961 A1 on 21 Mar. 2024, is incorporated by reference herein in its entirety.

As to SPARQL, a recursive acronym for SPARQL Protocol and RDF Query Language, is an RDF query language, for example, a semantic query language for databases able to retrieve and manipulate data stored in the Resource Description Framework (RDF) format. As an example, a framework may implement the Resource Description Framework (RDF), which is a World Wide Web Consortium (W3C) standard originally developed as a data model for metadata. The RDF may be utilized for description and exchange of graph data. RDF provides a variety of syntax notations and data serialization formats, for example, consider Turtle (Terse RDF Triple Language) as a type of notation.

As an example, one or more LLMs may effectively bridge a gap between human users and structured knowledge graphs, enabling natural language interaction with stored information. As shown in the workflow 400, which may be considered to illustrate an architecture of components, the workflow 400 may commence with a user posing a query 410 in a natural language. The query 410 may then be processed by an LLM 450, which leverages its understanding of language and a provided schema 432 (e.g., a schema specification, etc.) and demonstrations 434 (e.g., examples, etc.) to interpret the user's intent and translate it into a structured query compatible with the one or more knowledge graph databases 470. In such an example, the structured query may then be executed on at least one of the one or more knowledge graph databases 470 for retrieving relevant information. As shown, results 480 retrieved responsive to the structured query may be returned to a user.

As an example, consider a prompt to the LLM such as: You are a large language model with access to a knowledge graph database containing information about various entities and their relationships. Your task is to assist users in querying this knowledge graph by converting their natural language questions into SPARQL queries.

In such an example, a natural language query may be a user's question in plain English, expressing what information they want to retrieve from one or more knowledge graphs.

In such an example, a schema may provide information about the structure of one or more knowledge graphs, for example, including the types of entities and relationships present.

In such an example, demonstrations may be examples of previous natural language queries and their corresponding SPARQL translations, which may be utilized as references, for example, to learn mappings between natural language and SPARQL syntax.

In such an example, a valid SPARQL query may accurately captures the intent of a user's natural language question and may be executed on at least one of one or more knowledge graph databases to retrieve the desired information.

As an example, consider the following structure:
Natural Language Query: {demonstration query}
Schema: {demonstration example}
Output: {demonstration output}
Natural Language Query: {input query}
Schema: {input example}
Output:

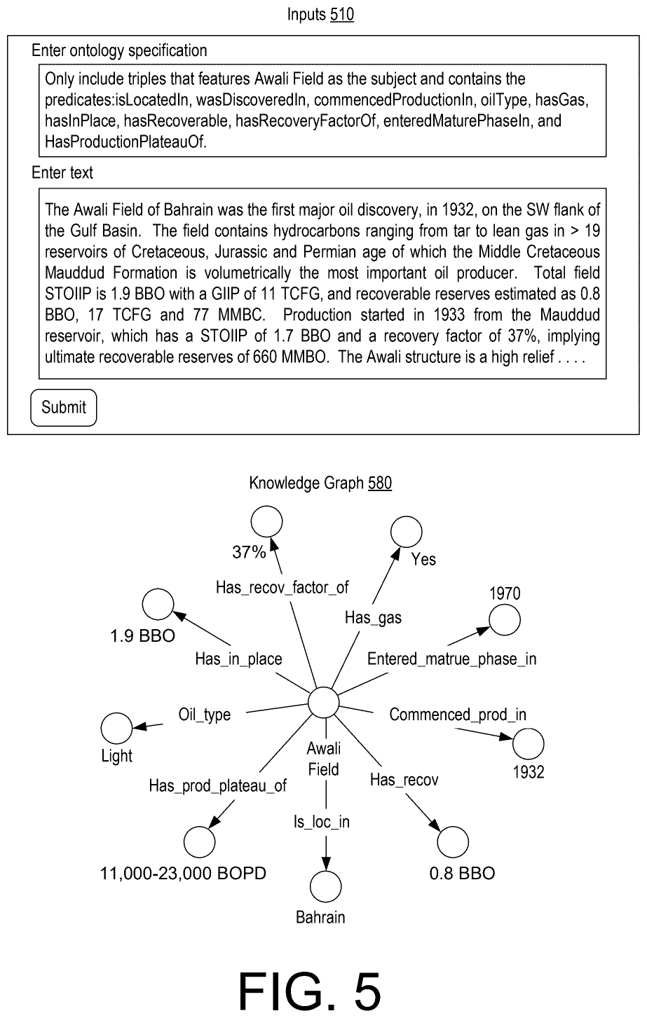

FIG. 5 shows examples of inputs 510 and an example of output 580, which may be a knowledge graph (e.g., a data structure suitable for presentation in graphical form). As shown, the inputs 510 can include an ontology specification (e.g., a schema specification) and text. Such an approach may utilize automated input, semi-automated input and/or manual input. As an example, input may be provided via an interface that may be a machine-machine interface (MMI), a human-machine interface (HMI), etc. As an example, one or more controllers may provide for generation of input directly and/or indirectly (e.g., consider a multimodal LLM that can operate using controller data to generate natural language input, etc.).

As shown, a submit button may be rendered to a GUI with fields for a specification, text, etc. As an example, one or more menus may be rendered where, for example, one or more specifications may be selected. As explained, an automated approach to specification selection may be utilized, which, for example, may be based at least in part on an assessment of text, a geographical location, a user, etc.

In the example of FIG. 5, the knowledge graph 580 includes nodes and edges where edges describe relationships between nodes. For example, in the Awali field, the oil type may be light where the Awali field is in Bahrain. Such an approach can provide for expedited understanding, monitoring and/or control of one or more wells, production equipment, etc., in a field. As an example, a knowledge graph may provide for rendering of relationships based at least in part on an ontology specification. In such an example, the ontology specification may be considered as instructions that direct operation of executable code for knowledge graph generation, which, as explained, may be rendered to a GUI that may provide for interactive graphical controls, for example, to select a portion of a knowledge graph for accessing data, imagery, etc. As an example, a GUI may provide for human-machine and/or machine-machine interactions where the GUI may be updated responsive to such interactions. As explained, a GUI may provide for generation of control instructions to control field equipment, framework operations, etc.

As an example, the relationship between the field and oil type (Oil_type) may be automatically revised according to real time analysis of production fluid. For example, consider field equipment that may provide for assessing fluid, such as, for example, fluid type, fluid phase, fluid composition, etc. In such an example, where a change occurs in production fluid the knowledge graph 580 may be automatically revised and rendered accordingly. For example, consider a change from light to heavy oil. Contrasting heavy oil, light oil may be defined as possessing an API gravity above 31.1 deg, making it less dense and more fluid. The lower viscosity of light oil means it flows more easily through pipelines and can demand less intensive refining. Compared to heavy oil, light oil may include fewer impurities like sulfur, nitrogen, and heavy metals, which may lead to a more straightforward refining process and higher yields of high-value products like gasoline and diesel. The production of light oil can involve drilling techniques that may be less expensive and less energy-intensive compared to techniques for heavy oil extraction.

As to some examples of field equipment that may provide for determinations as to production fluid consider, for example, multi-phase flow meters (MPFMs), separators, wellhead sensors (e.g., pressure, temperature, gas, water, etc.), etc. As an example, a database may be a real-time database operatively coupled directly and/or indirectly to field equipment where a knowledge graph generator (e.g., a framework, etc.) can access such a database and/or respond to changes data within the database (e.g., using time indicators, delta indicators representative of changes, etc.).

As an example, a knowledge graph may be a useful structure for storing information, allowing efficient storage and accessing of entities and their relationships with each other. As an example, a knowledge graph may include a set of triples. For example, consider triples in the form of “Subject|Predicate|Object.” For example, “Dog|is|Animal,” “Cat|is|Animal,” and “Labrador|is|Dog.” As shown in FIG. 5, the example knowledge graph 580 can convey relationships visually and provide for efficient structuring of data for storage, access, updates, etc.

Text may include rich, complex information; however, it may not be represented in a structured manner that is easy to understand and process by computer systems (e.g., monitoring, control, planning, etc.). As an example, a framework may provide for generation of knowledge graphs that store useful information as may be within text, such that the useful information may be more easily stored, accessed and/or modified. As an example, a framework may provide for automatically extracting a knowledge graph that represents useful information in text. As explained, a framework may provide for querying a knowledge graph and/or one or more databases of knowledge graphs. As an example, a framework may provide for database generation and database querying.

As an example, a framework may allow users (e.g., human and/or machine) to specify what type of information to be extracted from text, and what format output is to be formatted within (e.g., a graph suitable for humans, machines, etc.). As an example, a framework may be integrated into an environment such as, for example, a data ecosystem, the DELFI environment, LUMI platform, etc.

As explained, a framework may operate as a tool that takes a piece of text and generates a knowledge graph from the text. In such an example, inputs to the tool may include the text itself, one or more specifications that a user would like to make (e.g., about types of information to extract from the text and/or desired graph format) and an LLM that is to be use to generate the knowledge graph. In such an example, a user may have access to a specified language model.

Given inputs, a specific prompt may be generated where the prompt, which includes input text and specifications about graph generation, is fed into a specified LLM. The output of the LLM may be processed and utilized to construct a knowledge graph, which may be returned to a user, stored in a database, utilized for automated decision making, utilized for automated control, utilized for automated monitoring, etc.

As explained, a framework can generate knowledge graphs from text which can identify entities and link them across long text. As explained, such a framework may generate graphs which adhere to specific schema or ontology.

As explained, a framework may utilize different prompting and aggregation techniques, for example, to split text and reaggregate it. As example, specifically engineered prompts may be utilized to extract relevant information which adhere to one or more specified schema.

As an example, an LLM may be an existing, available LLM. As an example, an LLM may be customized using one or more techniques. As an example, an LLM may be a generated LLM, for example, consider an LLM generated through training using data from one or more sources as may be relevant to field operations, field sites, resources, etc.

As explained, a framework may be operable to provide for automatic information extraction, which may utilize an existing LLM/LLMs. Such a framework may be flexible and customizable. As explained, output may be structured in a manner where various types of information are linked (e.g., via nodes and edges, etc.).

As an example, a framework may provide for extraction of information from textual data and indexing thereof, for example, in a structured graph format for one or more purposes (e.g., discovery via search, machine language training, monitoring, control, planning, etc.).

As explained with respect to the example of FIG. 3, a user provided schema specification and pre-written examples may be merged to create a prompt. As explained, input text may be chunked (e.g., according to one or more criteria, etc.), if appropriate, and added to a prompt and fed into an LLM. In the instance that chunking is not called for, an LLM may output a final knowledge graph. In the instance that chunking has been performed, each chunk may be separately added to a prompt and an LLM may generate a corresponding output for each of the chunks. Such multiple outputs may then be added to a pre-written reaggregation prompt and fed into the LLM, which may then output a final knowledge graph. As explained, various components in the workflow 300 may be utilized conditionally, for example, where appropriate and/or desired. As an example, if a user does not specify a schema or input text is not too long relative to a context window of an LLM, various pathways of the workflow 300 may be bypassed.

As an example, input text may be chunked if and only if its length is longer than a preset threshold. Such an approach may help to prevent an overly long input to be fed into an LLM. In the instance that chunking is called for, input may be divided in such a way that there is a relatively small overlapping piece of text between every consecutive pair of chunks. As an example, an amount of overlap may be controllable and/or may be adjusted automatically. For example, consistency of output for two chunks may be assessed where if consistency is lacking, an amount of overlap may be increased. As an example, overlap may be determined on a chunk-to-chunk basis where, for example, some chunks may have a different amount of overlap compared to some other chunks. As an example, overlap may be specified in terms of number of characters, number of words, etc. As an example, chunk characteristics may be tuned for a framework. For example, consider using a training dataset for purposes of tuning chunk characteristics.

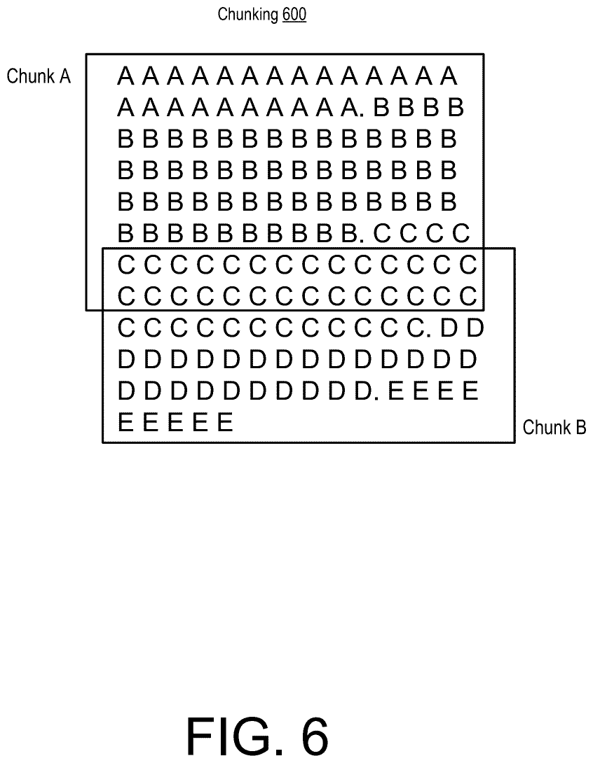

FIG. 6 shows an example of chunking 600 of input text utilizing various characters for purposes of illustration, noting that input text may include characters in the form of words, numbers, etc. In the example of FIG. 6, two chunks are illustrated, labeled A and B, where overlap exists between these two chunks. Such overlap may help to maintain meaning when a chunk is submitted to an LLM such that two chunks include some common meaning such that outputs of the LLM may also include some common meaning.

As an example, chunking may be utilized to improve performance of a framework, where, for example, greater contextual overlap may help preserve semantic fidelity of individual chunks. As an example, a framework may provide for automated chunking where, for example, chunking parameters may include character length, word length, sentence length, grammatical keying, overlap, etc. As an example, chunking may be context dependent where for certain contexts chunking overlap is increased whereas for other contexts chunking overlap may be decreased. As an example, an overall length may be a factor in determining one or more chunking parameters.

As an example, an RDF may provide for characterizing a directed graph composed of triple statements. For example, an RDF graph statement may be represented by: 1) a node for the subject, 2) an arc that goes from a subject to an object for the predicate, and 3) a node for the object. In such an example, each of the three parts of the statement may be identified by a Uniform Resource Identifier (URI). As an example, an object may also be a literal value. The RDF may provide a flexible data model with expressive power to represent complex situations, relationships, and other things of interest. As an example, a URI may provide for linking to one or more databases, one or more sensors, one or more controllers, etc. As explained, a triple may be linked to a live data source (e.g., consider example for oil type).

As mentioned, examples may be utilized to improve performance for a framework. As explained, a knowledge graph may be a list of RDF triples where, for example, an RDF triple may be structured as follows: Subject|Predicate|Object. As explained, a framework may generate a knowledge graph from text, which may utilize a schema specification, if available. As an example, a framework may provide for ignoring irrelevant information in text. As to examples, consider, for each triple, include an explanation on a new line. For example, consider one or more of the following:
[Triple] Margorie Field|wasDiscoveredin|1910
[Explanation] The text states that “Margorie Field was discovered in 1910.”
[Triple] Margorie Field|hasGas|No
[Explanation] The text does not mention that Margorie Field contains natural gas reserve.

As to a reaggregation prompt, as explained, a knowledge graph may be based on a list of RDF triples (e.g., Subject|Predicate|Object). Given several triples and their corresponding explanations, a framework may consolidate these into an accurate, non-repeating, and comprehensive knowledge graph, which may adhere to a schema specification, if available or utilized. As an example, a framework may identify triples (e.g., from chunks) that conflict with each other and apply one or more rules, etc., to resolve a conflict. As an example, a workflow may include providing an explanation for each triple generated from chunks (e.g., chunked inputs) where, for example, an approach may filter out or prohibit a triple based on various rules. As an example, triples may be provided without numbering (e.g., indexing). As to reaggregation, triples may be generated as outputs from chunked inputs. Reaggregation may aim to link entities across chunks, which may be performed in a manner to reduce conflicts, etc. As explained, where chunking is utilized, a framework may aim to generate a unified graph structure for an assembly of chunks. The framework may provide for generation of graph structures on a chunk-by-chunk basis, which may provide for comparing such graph structures to a unified graph structure.

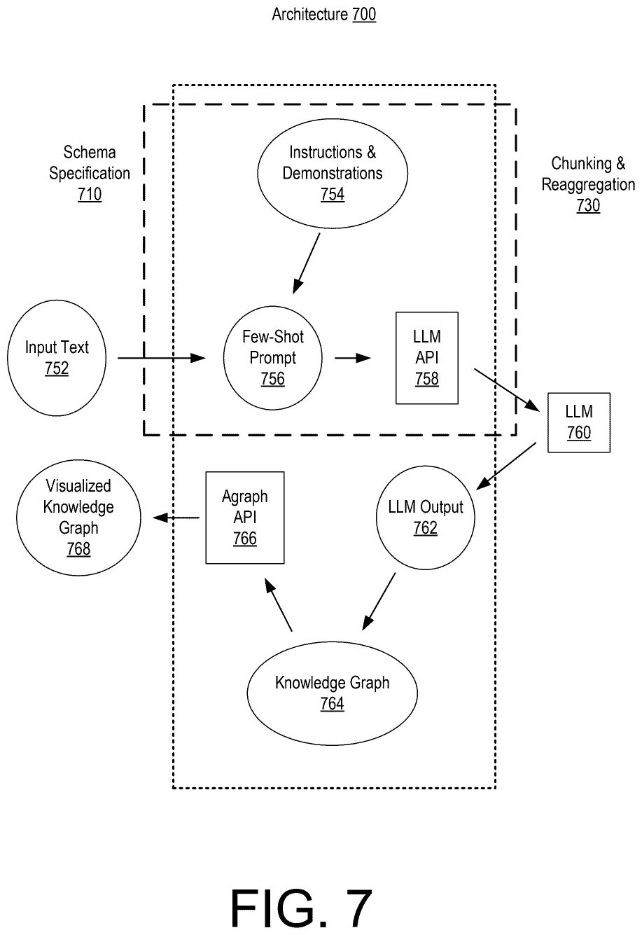

FIG. 7 shows an example of an architecture 700 that includes references to various libraries, etc. In the example of FIG. 7, the architecture 700 includes components for a schema specification 710 and components chunking and reaggregation 730. As shown, input text 752 may be received for few-shot prompt generation 756, which may be informed via instructions and demonstrations 754. As indicated, a few-shot prompt may be directed to an LLM 760 via an LLM application programming interface (API) 758. In such an example, output of the LLM, shown as LLM output 762, may be utilized for generation of a knowledge graph 764. As shown, an Agraph API 766 may utilize the knowledge graph 764 for generation of a visualized knowledge graph 768, as may be rendered to a display as part of a GUI, etc.

As to the Agraph API 766, consider, for example, the AllegroGraph API of Franz, Inc. (Lafayette, California). The AllegroGraph API is a horizontally scalable, high-performance, and transactional Semantic Graph Database that provides for data integration through unifying data and siloed knowledge into an Entity-Event Knowledge Graph solution for data analytics. The AllegroGraph API can utilize federated sharding capabilities for insights that enable complex reasoning across a distributed knowledge graph.

As explained, input may be from one or more sources, which may be from an MMI, an HMI, etc. As explained, input may be generated using a GUI, a controller, a live database, etc. In such an approach, the architecture 700 may be dynamic and responsive to changes in data, field operations, etc.

The architecture 700 may include a STREAMLIT application (Snowflake Inc., Bozeman, Montana) that may be utilized to extract a knowledge graph from a piece of text for an end user (e.g., human and/or machine). As shown, a user may provide the input text 752 where the application generates input(s) to feed into the LLM 760. After the final output 762 from the LLM 760 is received, it may be converted into the knowledge graph 764, which may then be presented as a visualized knowledge graph 768 to the user (e.g., for machine instructions, control, planning, workflow, mitigation action, etc.). As an example, a framework may generate a unified graph from chunked inputs and corresponding outputs. Such an approach may be able to handle input text in the form of single page documents, multiple page documents, etc., where, for example, an LLM may have a limited input window (e.g., limited number of words, characters, etc.).

As an example, one or more application programing interfaces (API) may be utilized. For example, consider the LLM API 758 that may receive a call with input to generate a response as output. As mentioned, a STREAMLIT application building platform may be utilized and/or one or more other suitable platforms. As an example, the PYTHON programming language may be utilized and/or one or more other suitable languages. As an example, the DATABRICKS platform may be utilized (Databricks, Inc., San Francisco, California), which is a cloud-based platform for helping build, scale, and govern data and AI, including generative AI and other machine learning models. As an example, one or more platforms may be utilized for one or more purposes. For example, consider the AZURE platform (Microsoft Corp., Redmond, Washington), the OpenAI platform (OpenAI, LLC, San Francisco, California), the PaLM platform (Alphabet Inc., London, England), the GEMINI platform (Alphabet Inc., London, England), the META platform (Meta Platforms, Inc., Menlo Park, California), etc. As an example, a framework may be utilized one or more LLMs, which may be a built LLM, an available LLM, etc.

As an example, an interface such as the PyGraphviz may be utilized, which is a PYTHON interface to for the Graphviz graph layout and visualization package. As an example, PyGraphviz may be implemented to create, edit, read, write, and draw graphs using PYTHON, for example, to access a Graphviz graph data structure and layout algorithms; noting that PyGraphviz provides a programming interface to NetworkX, which is a PYTHON package for creation, manipulation, and study of structure, dynamics, and functions of complex networks.

As an example, one or more formats may be utilized by a framework. As mentioned, the RDF may be utilized, which may be modified to provide more than a triple type of structure. As an example, a temporal aspect may be utilized, which may be controlled during visualization using one or more parameters.

As an example, a graph structure may provide for linking to one or more documents. For example, consider a GUI where a click on an edge may cause access to a particular document from which the edge was extracted. As an example, security measures may be utilized where, for example, a graph structure may be limited in terms of access to underlying data. For example, consider a database of graph structures where, depending on authorization, certain documents may or may not be available.

As an example, a graph structure may be linked to one or more other graph structures. For example, consider linking graph structures for wells within a field. As an example, a wiki-type of application may be generated for a well, a field, etc.

As shown in the example of FIG. 7, the architecture 700 may implement few-shot prompting (see, e.g., the few-shot prompt 756). Zero-shot or few-shot prompting may be considered to be an application of zero-shot or few-shot learning, noting differences in scope and technique. For example, zero-shot learning can be a machine learning paradigm that enables a model to recognize concepts it has never seen, while zero-shot prompting can be a technique for eliciting a response from a pre-trained large language model (LLM) without providing examples. As explained, in zero-shot prompting, a model may be prompted to generate a response without receiving an example of the desired output for a use case where zero-shot prompting is an application of zero-shot learning, which can be a machine learning pattern that asks models to make predictions with zero-training data. As an example, a few-shot approach may utilize fewer than approximately 15 examples or samples, which may be within the realm of human input and/or human labeling in a relatively short period of time; noting that automated examples or samples may be provided. As shown, in a few-shot prompting approach, the instructions and demonstrations 754 may provide for few-shot prompt generation, as indicated by the few-shot prompt 756.

As an example, a few-shot prompting process may be triggered responsive to receipt of input, which may be a query. In such an example, a vector store (e.g., a vector database) may be accessed that includes examples (samples) where the vector store may be optimized for semantic search, etc. In such an example, once input is received, a framework may perform semantic matching to find relevant examples from the vector store. As to retrieval of relevant examples for prompt formation (e.g., few-shot prompt formation), a technology, such as, for example, Retrieval-Augmented Generation (RAG) may be utilized, which may enhance a process by help to ensure that the most contextually relevant examples are selected to help improve LLM performance in certain scenarios. As an example, few-shot prompting may be considered to be a type of automated prompt enhancement, augmentation, etc. As an example, one or more rules may be utilized to filter or other control few-shot prompt engineering. As an example, few-shot prompting may provide for more efficient computation and LLM operation. As an example, one or more guardrails may be implemented at a time of prompt generation (e.g., prompt engineering), which may operate to constrain input, output, etc. For example, consider an approach where characteristics of a source of input may be utilized for implementing one or more guardrails (e.g., consider security, geography, etc.). As an example, prompt engineering may provide for reduced risk of LLM hallucinations, uncertainty, etc.

As an example, guardrails may be implemented to help filter input and/or output of one or more LLMs. As an example, one or more open-source technologies may be implemented, as appropriated programmed in advance, dynamically, etc. (e.g., LLaMA Guard, NVIDIA NeMo, Guardrails AI, etc.).

In various instances, while LLMs guardrails can include mechanisms to detect undesirable input and/or output, they may still pose a risk of generating biased or misleading responses. As an example, the architecture 700 of FIG. 7 may provide another level of control through use of knowledge graph generation and rendering. For example, generation of a knowledge graph can be limited to possible knowledge graph components, features, etc. In such an approach, undesirable LLM output may be automatically excluded. In such an approach, knowledge graph generation may be considered a type of filtering that can be applied to LLM output. As example, where knowledge graph generation acts to exclude certain LLM output, the excluded output may be utilized as feedback, for example, for improvement of prompt generation and/or guardrails. As an example, a knowledge graph generator may be tailored to a particular entity (e.g., company), machine (e.g., type of controller, etc.), human user, etc. For example, consider a programmable logic controller (PLC) that can operate using a knowledge graph where a knowledge graph generator can generate relationships that can be implemented by the PLC, which may be part of a workflow, a control scheme, etc. As explained, the example architecture 700 of FIG. 7 may provide for improved generation of output.

As an example, the architecture 700 may provide for one or more chunking operations, which, as explained, can be utilized for processing input, prompts, etc. As explained, a chunking process may include reaggregation of chunks and/or representations based on chunks, etc.

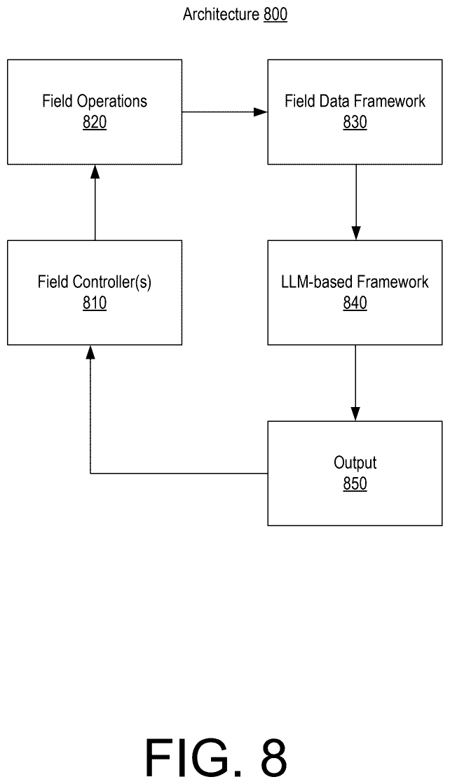

FIG. 8 shows an example of an architecture 800 that includes one or more field controllers 810, field operations 820, a field data framework 830, an LLM-based framework 840, and output 850 of the LLM-based framework 840. As shown, the output 850 may be transmitted to and received by at least one of the one or more field controllers 810 for controlling one or more of the field operations. In the example of FIG. 8, as the field operations 820 are performed, additional field data may be generated and stored, organized, etc., using the field data framework (e.g., consider the TECHLOG framework, etc.). In such an approach, the LLM-based framework 840 may generate one or more additional graphs, enlarge a graph, modify a graph, etc., based at least in part on field data. For example, as additional field data are received, a graph may be updated with the latest production rates, gas-to-oil ratio (GOR), oil type, number of wells online, etc. Such an approach may provide for structuring of data for improved decision-making and/or control.

As an example, a GUI may render a graph that is dynamically updated responsive to receipt of additional field data. In such an example, the GUI may provide for entry of one or more queries, etc., which may be utilized to find information in one or more graphs, which may be part of a graph database. For example, consider the architecture 800 as providing for generation of a graph database with graph structures over time where a query may be utilized to determine how one or more parameters evolved over time. For example, consider evolution of production rate, GOR, number of wells, etc.

As explained, graph structures may enhance efficiency for searching and/or may provide for training of one or more machine learning models. As an example, graphs may be utilized as images that may be training images for an image-based machine learning model. In such an approach, images and/or triples (e.g., or other data structures) may be utilized for training. As an example, a trained machine learning model may provide for classification and/or regression. For example, consider an approach that may classify field operations, field characteristics, etc., using a trained machine learning model. In such an approach, a graph may provide particular knowledge for querying while a graph may provide additional knowledge, whether via classification and/or regression (e.g., prediction).

As an example, a foundational GPT model may be further adapted to produce more targeted systems directed to specific tasks and/or subject-matter domains. Techniques for such adaptation may include additional fine-tuning (e.g., beyond tuning of a foundation model, etc.), certain forms of prompt engineering, etc. As an example, a large language model (LLM) may be a chatbot type of LLM. For example, consider the OpenAI ChatGPT LLM, which is an online chat interface powered by an instruction-tuned language model trained in a similar fashion to InstructGPT. Other chatbots may include features of GPT-4 (OpenAI), Bard (e.g., LaMDA family of conversation-trained language models, PaLM, etc.) (Alphabet Inc., London, England), etc.

As an example, a LLM Meta AI (LLaMA) LLM may be utilized, which includes a transformer architecture; noting some architectural differences compared to GPT-3. For example, LLaMA utilizes the SwiGLU activation function rather than ReLU, uses rotary positional embeddings rather than absolute positional embedding, and uses root-mean-squared layer-normalization rather than standard layer-normalization. Further, there may be an increase in context length from 2K (Llama 1) tokens to 4K (Llama 2) tokens between.

As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., näive Bayes, average on-dependence estimators, Bayesian belief network, Gaussian näive Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) (e.g., Lite Runtime or LiteRT or LRT) or another type of lightweight framework. LiteRT, formerly known as TensorFlow Lite, is a high-performance runtime for on-device AI that allows for use of ready-to-run LiteRT models and/or other models, for example, for a range of ML/AI tasks; noting that models may be converted (e.g., consider TensorFlow, PyTorch, JAX, etc., models) to the TFLite format using the AI Edge conversion and optimization tools. TFL or LRT is a set of tools that enables on-device machine learning where models may run on mobile, embedded, and IoT devices. LRT is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). LRT offers multiple platform support, covering ANDROID and iOS devices, embedded LINUX, and microcontrollers. LRT offers diverse language support, which includes JAVA, SWIFT, Objective-C, C++, and PYTHON. LRT offers high performance, with hardware acceleration and model optimization.

Machine learning tasks may include, for example, one or more of image classification, natural language processing (NLP), object detection, pose estimation, question answering, text classification, regression, etc., on one or more of multiple platforms.

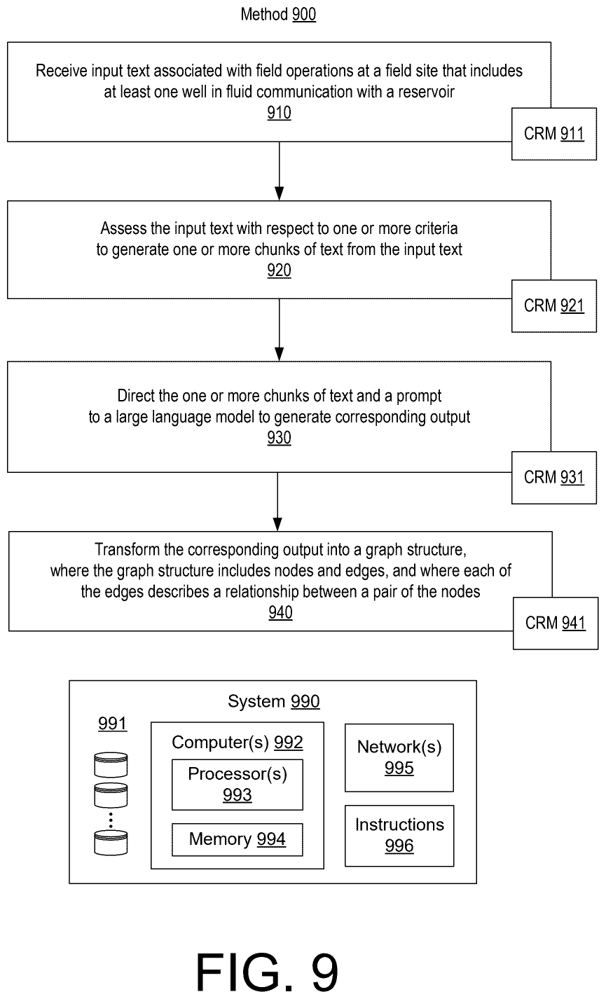

FIG. 9 shows an example of a method 900 and an example of a system 990. As shown, the method 900 can include a reception block 910 for receiving input text associated with field operations at a field site that includes at least one well in fluid communication with a reservoir; an assessment block 920 for assessing the input text with respect to one or more criteria to generate one or more chunks of text from the input text; a direction block 930 for directing the one or more chunks of text and a prompt to a large language model to generate corresponding output; and a transformation block 940 for transforming the corresponding output into a graph structure, where the graph structure includes nodes and edges, and where each of the edges describes a relationship between a pair of the nodes.

The method 900 is shown in FIG. 9 in association with various computer-readable media (CRM) blocks 911, 921, 931, and 941. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 900. As an example, a computer-readable medium (CRM) may be a computer-readable storage medium that is non-transitory and that is not a carrier wave. As an example, one or more of the blocks 911, 921, 931, and 941 may be in the form processor-executable instructions.

In the example of FIG. 9, the system 990 includes one or more information storage devices 991, one or more computers 992, one or more networks 995 and instructions 996. As to the one or more computers 992, each computer may include one or more processors (e.g., or processing cores) 993 and memory 994 for storing the instructions 996, for example, executable by at least one of the one or more processors 993 (see, e.g., the blocks 911, 921, 931, and 941). As an example, a computer may include one or more network interfaces (e.g., wired or wireless), one or more graphics cards, a display interface (e.g., wired or wireless), etc.

As an example, a method can include receiving input text associated with field operations at a field site that includes at least one well in fluid communication with a reservoir; assessing the input text with respect to one or more criteria to generate one or more chunks of text from the input text; directing the one or more chunks of text and a prompt to a large language model to generate corresponding output; and transforming the corresponding output into a graph structure, where the graph structure includes nodes and edges, and where each of the edges describes a relationship between a pair of the nodes. In such an example, the one or more criteria can include a text length criterion associated with a text length limit of the large language model.

As an example, one or more chunks can be multiple chunks where, for example, the multiple chunks include sequential chunks where each pair of sequential chunks include an overlap (e.g., overlapping portions of a pair of sequential chunks). In such example, an overlap may provide for contextual continuity.

As an example, a method may include reaggregating the corresponding output of multiple chunks using a reaggregation prompt. In such an example, the method may include submitting corresponding output and a reaggregation prompt to a large language model to generate unified output or to another large language model to generate unified output. In such an example, the method may include transforming the unified output into the graph structure.

As an example, input text can include text in one or more documents. As an example, input text can include text recognized in one or more documents via application of text recognition to the one or more documents. As an example, input text can include text generated from one or more graphics in one or more documents.

As an example, a method may include storing a graph structure to a database. In such an example, a method may include submitting a query to the database for generation of a result. In such an example, generation of the result may utilize one or more large language models to process the query.

As an example, input text can include digital data text received responsive to performance of one or more field operations. In such an example, a method may include dynamically adapting the graph structure based at least in part on additional digital data text. In such an example, a method may involve dynamic rendering responsive to one or more machine operations, whether field operations and/or computing operations that may be due to interactions with one or more machines and/or humans (e.g., using one or more human-machine-interfaces (HMIs)). As an example, one or more GUIs may be utilized for interactions where actions such as clicking on a button as a graphical control may instruction a computing system to take one or more actions.

As an example, a method can include controlling one or more field operations using a graph structure. As explained, a graph structure may be renderable to a display, for example, using display circuitry, graphics drivers, etc. In various examples, a graph structure may provide for interactions whether via machine-to-machine and/or human-to-machine. As explained, a graphical control may be a type of structure that can be rendered to a display and associated with executable instructions, for example, to execute one or more processes, which may provide for control of one or more field operations. For example, consider interactions that may result in issuance of one or more control commands to equipment such that the equipment acts in a desired manner (e.g., as part of a field operation, etc.).

As an example, a method may include generating instructions for rendering a graph structure to a display as part of an interactive graphical user interface. As explained, interaction with a graph structure may provide for triggering one or more actions, which may be machine-based actions (e.g., local, remote, local and/or remote, etc.).

As an example, a system can include a processor; a memory operatively coupled to the processor; and processor-executable instructions stored in the memory and executable to instruct the system to: receive input text associated with field operations at a field site that includes at least one well in fluid communication with a reservoir; assess the input text with respect to one or more criteria to generate one or more chunks of text from the input text; direct the one or more chunks of text and a prompt to a large language model to generate corresponding output; and transform the corresponding output into a graph structure, where the graph structure includes nodes and edges, and where each of the edges describes a relationship between a pair of the nodes.

As an example, one or more computer-readable storage media can include processor-executable instructions executable by a system to instruct the system to: receive input text associated with field operations at a field site that includes at least one well in fluid communication with a reservoir; assess the input text with respect to one or more criteria to generate one or more chunks of text from the input text; direct the one or more chunks of text and a prompt to a large language model to generate corresponding output; and transform the corresponding output into a graph structure, where the graph structure includes nodes and edges, and where each of the edges describes a relationship between a pair of the nodes.

As an example, a computer program product can include one or more computer-readable storage media that can include processor-executable instructions to instruct a computing system to perform one or more methods and/or one or more portions of a method.

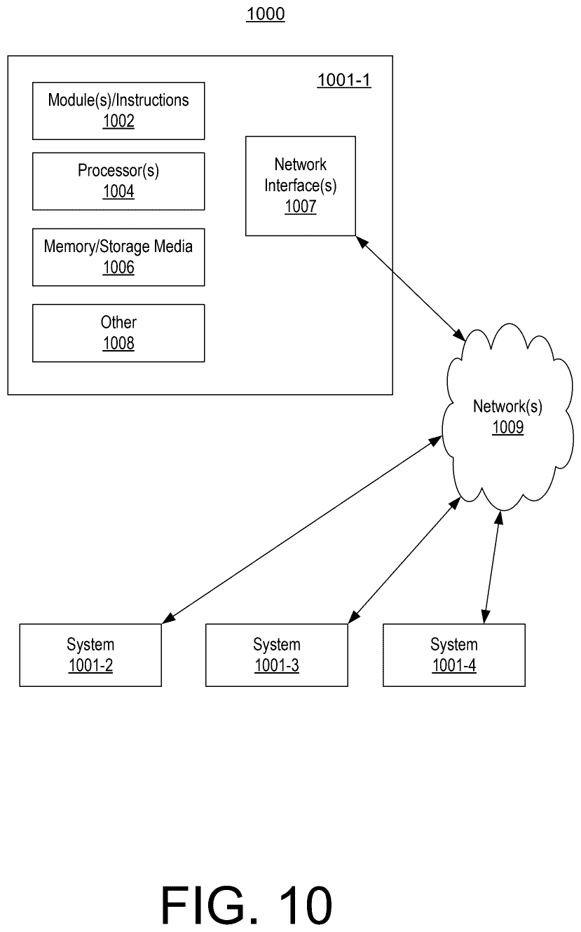

In some embodiments, a method or methods may be executed by a computing system. FIG. 10 shows an example of a system 1000 that can include one or more computing systems 1001-1, 1001-2, 1001-3 and 1001-4, which may be operatively coupled via one or more networks 1009, which may include wired and/or wireless networks.

As an example, a system can include an individual computer system or an arrangement of distributed computer systems. In the example of FIG. 10, the computer system 1001-1 can include one or more modules 1002, which may be or include processor-executable instructions, for example, executable to perform various tasks (e.g., receiving information, requesting information, processing information, simulation, outputting information, etc.).

As an example, a module may be executed independently, or in coordination with, one or more processors 1004, which is (or are) operatively coupled to one or more storage media 1006 (e.g., via wire, wirelessly, etc.). As an example, one or more of the one or more processors 1004 can be operatively coupled to at least one of one or more network interfaces 1007; noting that one or more other components 1008 may also be included. In such an example, the computer system 1001-1 can transmit and/or receive information, for example, via the one or more networks 1009 (e.g., consider one or more of the Internet, a private network, a cellular network, a satellite network, etc.).

As an example, the computer system 1001-1 may receive from and/or transmit information to one or more other devices, which may be or include, for example, one or more of the computer systems 1001-2, etc. A device may be located in a physical location that differs from that of the computer system 1001-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1006 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution. As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving input text associated with field operations at a field site that comprises at least one well in fluid communication with a reservoir;
assessing the input text with respect to one or more criteria to generate one or more chunks of text from the input text;
directing the one or more chunks of text and a prompt to a large language model to generate corresponding output; and
transforming the corresponding output into a graph structure, wherein the graph structure comprises nodes and edges, and wherein each of the edges describes a relationship between a pair of the nodes.

2. The method of claim 1, wherein the one or more criteria comprise a text length criterion associated with a text length limit of the large language model.

3. The method of claim 1, wherein the one or more chunks comprise multiple chunks.

4. The method of claim 3, wherein the multiple chunks comprise sequential chunks wherein each pair of sequential chunks comprises an overlap.

5. The method of claim 4, wherein the overlap provides for contextual continuity.

6. The method of claim 3, comprising reaggregating the corresponding output of the multiple chunks using a reaggregation prompt.

7. The method of claim 6, comprising submitting the corresponding output and the reaggregation prompt to the large language model to generate unified output or to another large language model to generate unified output.

8. The method of claim 7, transforming the unified output into the graph structure.

9. The method of claim 1, wherein the input text comprises text in one or more documents.

10. The method of claim 1, wherein the input text comprises text recognized in one or more documents via application of text recognition to the one or more documents.

11. The method of claim 1, wherein the input text comprises text generated from one or more graphics in one or more documents.

12. The method of claim 1, comprising storing the graph structure to a database.

13. The method of claim 12, comprising submitting a query to the database for generation of a result.

14. The method of claim 13, wherein the generation of the result utilizes one or more large language models to process the query.

15. The method of claim 1, wherein the input text comprises digital data text received responsive to performance of one or more of the field operations.

16. The method of claim 15, comprising dynamically adapting the graph structure based at least in part on additional digital data text.

17. The method of claim 1, comprising controlling one or more of the field operations using the graph structure.

18. The method of claim 1, comprising generating instructions for rendering the graph structure to a display as part of an interactive graphical user interface.

19. A system comprising:
a processor;
a memory operatively coupled to the processor; and
processor-executable instructions stored in the memory and executable to instruct the system to:
receive input text associated with field operations at a field site that comprises at least one well in fluid communication with a reservoir;
assess the input text with respect to one or more criteria to generate one or more chunks of text from the input text;
direct the one or more chunks of text and a prompt to a large language model to generate corresponding output; and
transform the corresponding output into a graph structure, wherein the graph structure comprises nodes and edges, and wherein each of the edges describes a relationship between a pair of the nodes.

20. One or more computer-readable storage media comprising processor-executable instructions executable by a system to instruct the system to:
receive input text associated with field operations at a field site that comprises at least one well in fluid communication with a reservoir;
assess the input text with respect to one or more criteria to generate one or more chunks of text from the input text;
direct the one or more chunks of text and a prompt to a large language model to generate corresponding output; and
transform the corresponding output into a graph structure, wherein the graph structure comprises nodes and edges, and wherein each of the edges describes a relationship between a pair of the nodes.
